(19) United States
(12) Patent Application Publication
(10) Pub. No.: US 2025/0382188 A1
(43) Pub. Date: Dec. 18, 2025

(54) Method For Recovering Silicate from Polymeric Composition Comprising Silica

(71) Applicant: Rhodia Operations, Lyon (FR)

(72) Inventors: Pascal Metivier, Lyon (FR); Wenjuan Zhou, Minhang District, Shanghai (CN); Stephane Streiff, Lyon (FR); Thomas Chaussee, Lyon (FR); Andong Feng, Minhang District, Shanghai (CN)

(21) Appl. No.: 18/878,179

(22) PCT Filed: Jun. 24, 2022
(86) PCT No.: PCT/CN2022/101026

§ 371 Date: Dec. 23, 2024

(51) Int. Cl. C01B 33/32; C08J 11/04

(52) U.S. Cl. CPC C01B 33/325; C08J 11/04; C08J 2317/00

(57) ABSTRACT

The present disclosure relates to a method for recovering a silicate from a polymeric composition comprising silica, which features mild reaction conditions. Advantageously, it is possible to recover silicates without degrading or depolymerizing the polymeric compositions.

### CROSS-REFERENCE TO RELATED APPLICATION

This application is the United States national phase of International Patent Application No. PCT/CN2022/101026 filed Jun. 24, 2022, the disclosure of which are hereby incorporated by reference in its entirety.

### BACKGROUND OF THE INVENTION

### Field of the Invention

The present disclosure relates to a method for recovering a silicate from a polymeric composition comprising silica.

### Description of Related Art

The following discussion of the prior art is provided to place the disclosure in an appropriate technical context and enable the advantages of it to be more fully understood. It should be appreciated, however, that any discussion of the prior art throughout the specification should not be considered as an express or implied admission that such prior art is widely known or forms part of common general knowledge in the field.

The use of precipitated silica as a reinforcing filler in polymeric compositions is known. In particular it is known to use precipitated silica as reinforcing filler in elastomeric compositions. Such use is highly demanding: the filler has to readily and efficiently incorporate and disperse in the elastomeric composition and, typically in conjunction with a coupling agent, enter into a chemical bond with the elastomer(s) on one side and silica on the other side, to lead to a high and homogeneous reinforcement of the elastomeric composition. In general, precipitated silica is used in order to improve the mechanical properties of the elastomeric composition as well as handling and abrasion performance.

The polymeric compositions comprising silica, such as automobile tires are the classic example of product derived from non-renewable petroleum resources. Currently, thermal pyrolysis is considered as a beneficial industrial process to add value to the waste rubber compounds by the recovery of the material and energy. However, it is necessary to use high temperature. In general, the ways to utilize such non-renewable petroleum resources are inefficient. There is risk of contaminating the local environment when waste polymeric compositions are not properly disposed of and the residue is not easy to reuse. Silica is barely never recycled with such a process and is often considered as a “poison”. Its removal before or after any further treatment could be beneficial for revalorising other residues.

As such, there remains a need for developing a method for recovering a silicate from the polymeric composition comprising silica, especially from scrapped tires that could be out of spec (performance, size . . . and so on) or even from scrapped process rubber formulations.

### SUMMARY OF THE INVENTION

The aim of the present disclosure is then to provide a method for recovering a silicate from a polymeric composition comprising silica, which features mild reaction conditions.

Thus, the present disclosure is directed to a method for recovering a silicate from a polymeric composition comprising silica, comprising the following steps:
(i) contacting a polymeric composition comprising silica with a base in the presence of a solvent,
(ii) allowing the base to react with the silica to form a silicate, thereby obtaining a polymeric composition having lost at least part of the silica and a solution comprising the silicate, and
(iii) separating the solution obtained at step (ii) from the polymeric composition obtained at step (ii).

Other subjects and characteristics, aspects and advantages of the present disclosure will emerge even more clearly on reading the detailed description and the examples that follow.

### BRIEF DESCRIPTION OF THE DRAWING

FIG. 1 Particle size distribution of the tire powder prepared in Examples.

### DEFINITIONS

In the present specification, the terms “silica” and “precipitated silica” are used as synonyms.

Throughout the description, including the claims, the term “comprising one” should be understood as being synonymous with the term “comprising at least one”, unless otherwise specified, and “between” should be understood as being inclusive of the limits.

As used herein, the terminology “(Cₙ-Cₘ)” in reference to an organic group, wherein n and m are both integers, indicates that the group may contain from n carbon atoms to m carbon atoms per group.

The articles “a”, “an” and “the” are used to refer to one or to more than one (i.e., to at least one) of the grammatical object of the article.

The term “and/or” includes the meanings “and”, “or” and also all the other possible combinations of the elements connected to this term.

It is specified that, in the continuation of the description, unless otherwise indicated, the values at the limits are included in the ranges of values which are given.

Ratios, concentrations, amounts, and other numerical data may be presented herein in a range format. It is to be understood that such a range format is used merely for convenience and brevity and should be interpreted flexibly to include not only the numerical values explicitly recited as the limits of the range, but also all the individual numerical values or sub-ranges encompassed within that range as if each numerical value or sub-range is explicitly recited.

### DESCRIPTION OF THE INVENTION

The present disclosure provides a method for recovering a silicate from a polymeric composition comprising silica, comprising the following steps:
(i) contacting a polymeric composition comprising silica with a base in the presence of a solvent,
(ii) allowing the base to react with the silica to form a silicate, thereby obtaining a polymeric composition having lost at least part of the silica and a solution comprising the silicate, and
(iii) separating the solution obtained at step (ii) from the polymeric composition obtained at step (ii).

The term “polymeric composition” is used herein to refer to a composition comprising at least one polymer. The phrase “at least one” when referring to the polymer in the composition is used herein to indicate that one or more than one polymer of each type can be present in the composition.

The expression “copolymer” is used herein to refer to polymers comprising recurring units deriving from at least two monomeric units of different nature.

The at least one polymer can be selected among the thermosetting polymers and the thermoplastic polymers, the latter being preferred.

Notable, non-limiting examples of suitable thermoplastic polymers include styrene-based polymers such as polystyrene, (meth) acrylic acid ester/styrene copolymers, acrylonitrile/styrene copolymers, styrene/maleic anhydride copolymers, ABS; acrylic polymers such as polymethylmethacrylate; polycarbonates; polyamides; polyesters, such as polyethylene terephthalate and polybutylene terephthalate; polyphenylene ethers; polysulfones; polyaryletherketones; polyphenylene sulfides; thermoplastic polyurethanes; polyolefins such as polyethylene, polypropylene, polybutene, poly-4-methylpentene, ethylene/propylene copolymers, ethylene/α-olefins copolymers; copolymers of α-olefins and various monomers, such as ethylene/vinyl acetate copolymers, ethylene/(meth) acrylic acid ester copolymers, ethylene/maleic anhydride copolymers, ethylene/acrylic acid copolymers; aliphatic polyesters such as polylactic acid, polycaprolactone, and aliphatic glycol/aliphatic dicarboxylic acid copolymers.

The silica may advantageously be present in elastomeric compositions as reinforcing filler. Notable non-limiting examples of suitable elastomers are diene elastomers. For example, use may be made of elastomers deriving from aliphatic or aromatic monomers, comprising at least one unsaturation such as, in particular, ethylene, propylene, butadiene, isoprene, styrene, acrylonitrile, isobutylene or vinyl acetate, polybutyl acrylate, or their mixtures. Mention may also be made of functionalized elastomers, that is elastomers functionalized by chemical groups positioned along the macromolecular chain and/or at one or more of its ends (for example by functional groups capable of reacting with the surface of the silica), and halogenated polymers. Mention may be made of polyamides, ethylene homo-and copolymer, propylene homo-and copolymer. Other suitable elastomers are those including chloro-or bromo-butyl monomers (like bromo-butylene for instance).

Among diene elastomers mention may be made, for example, of polybutadienes (BRs), polyisoprenes (IRs), butadiene copolymers, isoprene copolymers, or their mixtures, and in particular styrene/butadiene copolymers (SBRs, in particular ESBRs (emulsion) or sSBRs (solution)), isoprene/butadiene copolymers (BIRs), isoprene/styrene copolymers (SIRs), isoprene/butadiene/styrene copolymers (SBIRs), ethylene/propylene/diene terpolymers (EPDMs), and also the associated functionalized polymers (exhibiting, for example, pendant polar or reactive groups or polar groups at the chain end, which can interact or react with the silica).

Mention may also be made of natural rubber (NR) and epoxidized natural rubber (ENR).

The polymer compositions can be vulcanized with sulfur or crosslinked, in particular with peroxides or other crosslinking systems (for example diamines or phenolic resins).

The type of silica according to the disclosure is not particularly limited. It can be a conventional or a highly dispersible silica, such as Zeosil® Premium SW, Zeosil® Premium 200MP, Zeosil® 1165MP, Zeosil® 1115MP or Zeosil® 1085 GR (commercially available from Solvay).

The surface area of the mesporous silica (CTAB as template) according to the present disclosure may be from 40 to 500 m²/g.

The BET surface area of the silica according to the present disclosure may be from 40 to 500 m²/g.

The proportion by weight of silica in the polymer composition can vary within a fairly wide range. It normally represents from 0.01% to 40%, in particular from 10% to 40%, especially from 20% to 40%, with relation to the amount of the polymer(s).

The % are sometimes referred to as phr or Per Hundred Rubber in case of elastomeric compositions. Preferably, silica in the polymer composition may be from 5 to 200 phr and more preferably from 5 to 150 phr.

It was found by the Applicant that the higher the silica content in the polymer composition, the higher the recovery efficiency of silicate.

In some embodiments, the polymer composition may additionally comprise other reinforcing inorganic filler, such as nanoclays, alumina, or an organic reinforcing filler, such as carbon black, carbon black nanotubes, graphene, starch, cellulose and the like.

Silica according to the present disclosure then preferably constitutes at least 5% by weight, preferably at least 30%, more preferably 60%, indeed even at least 80% by weight, of the total amount of the reinforcing filler.

In a preferred embodiment, the polymer composition comprising silica and carbon black. The proportion by weight of silica and carbon black can be from 1% to 50%, with relation to the amount of the polymer(s).

Advantageously, the polymeric composition comprising silica, in particular the polymeric composition comprising silica recovered from a tire, especially a scrapped tire, can be provided in the form of powder. The skilled person can determine the measurement method, such as scanning electron microscope (SEM), particle size distribution analyzer (PSD) or vernier caliper to obtain the average particle size and/or particle size distribution, depending on the treatment processes such as cryogenic grinding, shreading process and crushing process.

For SEM analysis, a ZEISS EVO-18 with tungsten Filament having a voltage of 20 kV equipped with backscattered electron detector (BSD) or secondary electrons detector was used. The magnification can achieve up to 50K˜100K. The SEM was used to detect the particle size between 200 nm-1000 μm. Particles were deposed on a layer of graphite tape, coated by Pt for 40 s and measured by SEM. The obtained results were analyzed using the SmartSEM software. For each sample, around ten pictures were taken and a total of 100 particles were analyzed for obtaining the described size distribution. From this size distribution, the average particle size of the particles was obtained. The software used to measure the size of the particles was ImageJ thereby approximating the particles to be irregular shapes with measuring the longest distance. After setting the scale, the longest diameter of the particles was manually measured one by one to a total number of particles measured of 100. Every particle has been measured 3 times to obtain an average size.

For particle size distribution analyzer (PSD), a Malvern Mastersizer 3000 with range lens of 300RF mm was used. The PSD was used to detect the particle size range from 10 nm to 3.5 mm. Particles were dissolved in ethanol and the mixture was stirred for 10 mins. The dispersed sample passes though the measurement area of the optical bench, where a laser beam illuminates the particles. A series of detectors then accurately measure the intensity of light scattered by the particles within the sample for both red and blue light wavelengths and over a wide range of angles. At least three parallel samples were prepared and measured to obtain a particle size distribution, such as D10, D50 and D90. Particle size distribution D10, D50, and D90 represents the 10%, 50% or 90% of particles in the powders are smaller than the size in this range.

For ruler analysis, a vernier caliper is used to measure the particle size more than 1000 μm. The longest diameter of each particle was manually measured. Ca. 100 particles were measured to obtain average of particle size distribution.

The method for preparing the powder is not particularly limited. For example, the skilled person can use mechanical forces like crushing (pulverizing, rolling, and jawing), grinding (with ball and rod) or even shredding to prepare the powder. In a preferred embodiment, the powder can be prepared by cryogenic grinding.

The polymeric composition comprising silica, in particular the polymeric composition comprising silica recovered from a tire, especially a scrapped tire, may need pretreatment. It can be understood by the skilled person that different parts of scrapped tires may need different pretreatment.

For example, tire tread, which is a silica rich part, can be removed from a tire by a machine having a blade system, and then shredded and grinded.

As another example, when pretreating a non-tread part of the scrapped tire or the whole scrapped tire, the skilled person can firstly powder the non-tread part or the whole tire and then remove the metallic part and fibrous part in the tire. For instance, the pretreatment can be a method disclosed by US 2017/0043351, which comprises steps of pre-grinding processing, cryogenic freezing, and grinding of infeed material and warming, ferrous metal and fiber removal, accumulation, screening, and storage of micronized powder. The pretreatment can also be a method comprising steps of shredding processing, metal removal, and fiber removal.

The term “base” is used herein to refer to one or more than one base. Any base may be used in the method as long as it can react with silica to form a silicate. Non-limiting examples of suitable bases are inorganic bases, such as alkali metal hydroxides, alkali earth metal hydroxides and ammonia. Preferably, the base can be sodium hydroxide or potassium hydroxide.

The solvent according to the present disclosure is not particularly limited. Advantageously, the solvent is stable under alkaline condition. It can be water, an organic solvent or their mixture. Said organic solvent preferably has a total Hansen solubility parameter less than 33 MPa^{1/2}, preferably between 15 to 29 MPa^{1/2}, more preferably from 20 to 25 MPa^{1/2}.

Preferably, the solvent can comprise water. In this case, when the base is an inorganic base, it can be advantageously dissolved in the water to form an aqueous solution before contacting the polymeric composition. The concentration of the base in the aqueous solution can be advantageously from 4 wt. % to 50 wt. % and preferably from 8 wt. % to 40 wt. %, with respect to the total weight of the aqueous solution.

In some embodiments, the solvent can consist of water.

In some embodiments, the solvent can be a mixture of water and an organic solvent. Said organic solvent can be selected from the group consisting of toluene, xylene, acetone, DMSO and alcohols. Preferably, said organic solvent can be selected from the group consisting of DMSO, toluene, acetone, 1-propanol, 2-propanol, 2-butanol and tert-butyl alcohol, more preferably from the group consisting of toluene, acetone, 1-propanol, 2-propanol, 2-butanol and tert-butyl alcohol and most preferably from the group consisting of 1-propanol, 2-propanol and 2-butanol.

In a particular embodiment, when the solvent is a mixture of water and an organic solvent, the volume ratio of water to the organic solvent can be from 0.1:1 to 10:1 and preferably from 0.2:1 to 3:1.

The molar ratio of the base to silica can be advantageously from 40:1 to 1:1, preferably from 20:1 to 2:1, and more preferably from 5:1 to 2:1.

The reaction temperature in step (ii) can be from 25 to 180° C., preferably from 40 to 120° C. and more preferably 70 to 100° C.

The reaction time in step (ii) can be from 2 to 48 hrs and preferably from 3 to 24 hrs.

The reactor can be preferably made of a material resistant to the above mentioned organic solvent and base, such as Teflon and hastelloy.

The method for separating the solution and the polymeric composition in step (iii) is not particularly limited. Said method can be centrifugation and/or decantation, depending on the particle size.

Advantageously, it is possible to recover silicates without degrading or depolymerizing the polymeric compositions by using the method according to the present disclosure.

Advantageously, at least 50 wt. %, preferably at least 60 wt. %, more preferably at least 80 wt. % silica with respect to the total weight of silica in the polymer composition is recovered, calculated based on the silicon content in the solution obtained at step (iii).

The silicate recovered by the method according to the present disclosure can be advantageously used for manufacturing silica, especially precipitated silica.

The precipitated silica can be manufactured from the recovered silicate by processes that are well known to the skilled person. Such processes typically include causing the recovered silicate to react with an acid in an aqueous solution to obtain a slurry comprising precipitated silica particles. Such processes also typically include filtering and, if necessary, washing the slurry to obtain a suspension of silica particles (the “filter cake”), and drying the filter cake to obtain the precipitated silica in the form of a powder. A suitable process, among many other ones, is described and exemplified in U.S. Pat. No. 11,241,370, the whole content of which is herein incorporated by reference for all purposes.

The term “acid” is used herein to refer to one or more than one acid which can be added during the course of the inventive method. Any acid may be used in the method. Use is generally made of a mineral acid, such as sulfuric acid, nitric acid, phosphoric acid or hydrochloric acid, or of an organic acid, such as carboxylic acids, e.g. acetic acid, formic acid or carbonic acid. Good results are obtained with sulphuric acid.

It can be understood by the skilled the person that the pH of the solution is reduced when the acid is added. Preferably, the pH can be reduced to a value of below 6 and more preferably below 5.

Advantageously, the method according to the present disclosure can be used for a scrapped tire recycling, which contributes to the manufacture of silicate or precipitated silica.

The following examples are included to illustrate embodiments of the disclosure. Needless to say, the disclosure is not limited to describe examples.

### EXPERIMENTAL PART

### Materials

Simplified green tire tread formulation sheet (Solvay) containing SiO₂ of 32 wt. %;
Sodium hydroxide (CAS: 1310-73-2, >96%, Sinopharm);
Dimethyl sulfoxide (DMSO) (CAS: 67-68-5, 99%, J&K);
Tert-butyl alcohol (CAS: 75-65-0, 99.5%, J&K);
Ethylene glycol (CAS: 107-21-1, 99.5%, J&K);
Acetone (CAS: 67-64-1, ≥99.5%, AR Sinopharm);
Toluene (CAS: 108-88-3, ≥99.5%, AR, Sinopharm);
1-Propanol (CAS: 71-23-8, ≥96%, Sinopharm);
2-Propanol (CAS: 67-63-0, ≥96%, Sinopharm);
2-Butanol (CAS: 78-92-2, CP, Sinopharm);
Ethanol (CAS: 64-17-5, ≥95%, Sinopharm).

### Preparation of Green Tire Powder

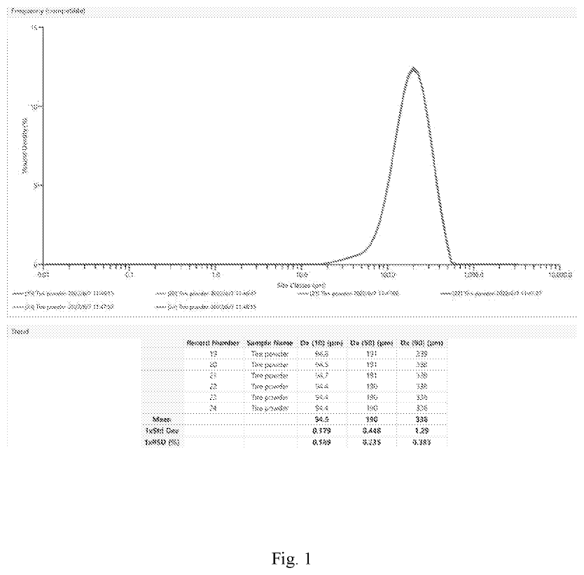

A simplified green tire tread formulation sheet prepared by Solvay was shredded and cut into powder. The particle distribution of powder was determined by particle size distribution analyzer (PSD), a Malvern Mastersizer 3000. Tire powder were dispersed ethanol in sample unit while stirring, allow about 10 minutes for the sample to disperse evenly. The testes were repeated for 6 times to ensure consistent results as shown by FIG. 1. According to PSD, 90% of particles with diameter are below 338 μm, 50% of particles with diameter are below 190 μm and 10% of particles with diameter are below 94.5 μm.

### Example 1

Tire treated by aqueous NaOH solution without organic solvent.

In a typical procedure, green tire powder (1.5 g) and aqueous NaOH solution (33 wt. %, 15 ml) were sequentially added into a Teflon reactor equipped with a Teflon condenser. The mixture was heated at 85° C. and stirred for 22 hours. After the reaction, the mixture was transferred into a centrifuge tube. Mixed EtOH and H₂O (20 mL) was used to wash the reactor in order to completely remove the solvent and residual tire from reactor into the centrifuge tube. The mixture was centrifuge at 10000 rpm for 5 mins to separate tire from liquid. The separated liquid was stored into a container, and then fresh mixed EtOH and H₂O was added into the centrifuge tube in order to remove the residual NaOH from tire. This procedure was repeated several times until the pH of separated liquid was equal 7. Finally, the wet tire was dried at 100° C. under vacuum. All the separated liquid in the container was concentrated into 50 ml by evaporation under 40° C. and 60 mbar. The silicon content in liquid and the silicon amount in the remaining tire was quantified by ICP. From the equations below to calculate extracted SiO₂ amount in liquid, remaining SiO₂ amount in tire and SiO₂ mass balance before and after reaction.

$${SiO}_{2 } wt . \% ( liquid ) = \frac{Mass {SiO}_{2} ( liquid )}{Original mass {SiO}_{2} ( tire )} * 100 \%$$

$$Mass {SiO}_{2} ( liquid ) = Si wt . \% ( ICP , liquid ) * mass ( liquid ) * \frac{60}{28} / 100$$

$$Ext . {SiO}_{2} wt . \% ( tire ) = 100 - \frac{Remaining mass {SiO}_{2} ( tire )}{Original mass {SiO}_{2} ( tire )} * 100 \%$$

$$Remaining mass SiO2 ( tire ) = Si wt . \% ( ICP , tire ) * mass ( remaining tire ) * \frac{60}{28} * 100$$

$${SiO}_{2} mass balance \% = \frac{Mass {SiO}_{2} ( liquid ) + remaining mass SiO2 ( tire )}{Original mass {SiO}_{2} ( tire )} * 100 \%$$

### Example 2

Tire treated by aqueous NaOH solution and 2-propanol.

In a typical procedure, green tire powder (1.5 g), aqueous NaOH solution (33 wt. %, 15 ml) and 2-propanol (10 ml) were sequentially added into a Teflon reactor equipped with a Teflon condenser. The mixture was heated at 82° C. and stirred for 22 hours. After the reaction, the mixture was transferred into a centrifuge tube. Mixed EtOH and H₂O (20 mL) was used to wash the reactor in order to completely remove the solvent and residual tire from reactor into the centrifuge tube. The mixture was centrifuge at 10000 rpm for 5 mins to separate tire from liquid. The separated liquid was stored into a container, and then fresh mixed EtOH and H₂O was added into the centrifuge tube in order to remove the residual NaOH from tire. This procedure was repeated several times until the pH of separated liquid was equal 7. Finally, the wet tire was dried at 100° C. under vacuum. All the separated liquid in the container was concentrated into 50 ml by evaporation under 40° C. and 60 mbar. The silicon content in liquid and the silicon amount in the remaining tire was quantified by ICP.

### Example 3

Tire treated by aqueous NaOH solution and 1-propanol.

The reaction protocol is similar as example 2 except the addition of 1-propanol of 10 ml.

### Example 4

Tire treated by aqueous NaOH solution and 2-butanol.

The reaction protocol is similar as example 2 except the addition of 2-butanol of 10 ml.

### Example 5

Tire treated by aqueous NaOH solution and tert-butyl alcohol. The reaction protocol is similar as example 2 except the addition of tert-butyl alcohol of 10 ml.

### Example 6

Tire treated by aqueous NaOH solution and toluene.

The reaction protocol is similar as example 2 except the addition of toluene of 10 ml and reaction temperature at 105° C.

### Example 7

Tire treated by aqueous NaOH solution and acetone.

The reaction protocol is similar as example 2 except the addition of acetone of 10 ml and reaction temperature at 105° C.

### Example 8

Tire treated by aqueous NaOH solution and dimethyl sulfoxide (DMSO).

The reaction protocol is similar as example 2 except the addition of DMSO of 10 ml and reaction temperature at 105° C.

### Example 9

Tire treated by aqueous NaOH solution and ethylene glycol.

The reaction protocol is similar as example 2 except the addition of ethylene glycol of 10 ml.

TABLE 1
Effect of organic solvents

| | | SiO₂ | | SiO₂ |
|---|---|---|---|---|
| | | wt. % | Ext. SiO₂ | mass |
| Exp. No. | Organic Solvent | (liquid) | wt. % (tire) | balance % |
| Example 1 | — | 26 | 27 | 98 |
| Example 2 | 2-propanol | 94 | 91 | 102 |
| Example 3 | 1-propanol | 85 | 86 | 98 |
| Example 4 | 2-butanol | 92 | 93 | 98 |
| Example 5 | tert-butyl alcohol | 66 | 69 | 97 |
| Example 6 | toluene | 64 | 65 | 98 |
| Example 7 | acetone | 62 | 63 | 98 |
| Example 8 | DMSO | 55 | 58 | 98 |
| Example 9 | ethylene glycol | 16 | 24 | 92 |

The ICP analytical error can be ±3%.

Table 1 shows that various solvents combined with NaOH solution can be used for the extraction of SiO₂ from tire. Among them, 2-propanol is the most effective solvent.

### Example 10

Tire treated by aqueous NaOH solution and DMSO.

The reaction protocol is similar as example 8 except the addition of NaOH aqueous (concentration of 18 wt. %) solution of 15 ml.

### Example 11

Tire treated by aqueous NaOH solution and tert-butyl alcohol.

The reaction protocol is similar as example 5 except the addition of NaOH aqueous (concentration of 18 wt. %) solution of 15 ml.

TABLE 2
Effect of concentration of NaOH solution

| | | NaOH | SiO₂ | | SiO₂ |
|---|---|---|---|---|---|
| | Organic | conc. | wt. % | Ext. SiO₂ | mass |
| Exp. No. | Solvent | wt. % | (liquid) | wt. % (tire) | balance % |
| Exemple 10 | DMSO | 18 | 48 | 44 | 104 |
| Exemple 11 | tert-butyl | | 55 | 55 | 100 |
| | alcohol | | | | |
| Example 8 | DMSO | 33 | 55 | 58 | 98 |
| Example 5 | tert-butyl | | 66 | 69 | 97 |
| | alcohol | | | | |

The ICP analytical error can be ±3%.

1. A method for recovering a silicate from a polymeric composition comprising silica, said method comprising the following steps:
(i) contacting a polymeric composition comprising silica with a base in the presence of a an organic solvent or a mixture of water and an organic solvent,
(ii) allowing the base to react with the silica to form a silicate, thereby obtaining a polymeric composition having lost at least part of the silica and a solution comprising the silicate, and
(iii) separating the solution obtained at step (ii) from the polymeric composition obtained at step (ii).

2-16. (canceled)

17. The method according to claim 1, wherein the solvent is a mixture of water and an organic solvent.

18. The method according to claim 17, wherein the volume ratio of water to the organic solvent is from 0.1:1 to 10:1.

19. The method according to claim 18, wherein the volume ratio of water to the organic solvent is from 0.2:1 to 3:1.

20. The method according to claim 17, wherein the organic solvent has a total Hansen solubility parameter less than 33 MPa^{1/2}.

21. The method according to claim 20, wherein the organic solvent has a total Hansen solubility parameter between 15 and 29 MPa^{1/2}.

22. The method according to claim 21, wherein the organic solvent has a total Hansen solubility parameter from 20 to 25 MPa^{1/2}.

23. The method according to claim 17, wherein the organic solvent is selected from the group consisting of toluene, xylene, acetone, DMSO and alcohols.

24. The method according to claim 23, wherein the organic solvent is selected from the group consisting of DMSO, toluene, acetone, 1-propanol, 2-propanol, 2-butanol and tert-butyl alcohol.

25. The method according to claim 24, wherein the organic solvent is selected from the group consisting of 1-propanol, 2-propanol and 2-butanol.

26. The method according to claim 17, wherein the molar ratio of the base to silica is from 40:1 to 1:1.

27. The method according to claim 17, wherein the base reacts with silica under a temperature from 25 to 180° C.

28. The method according to claim 17, wherein the base is an organic base and which comprises dissolving the base in the water to form an aqueous solution before contacting it with the polymeric composition.

29. The method according to claim 17, wherein the proportion by weight of silica in the polymer composition is 0.1% to 40%, with relation to the amount of the polymer(s).

30. The method according to claim 17, wherein the polymeric composition comprising silica is in the form of powder.

31. The method according to claim 17, which further comprises recovering the polymeric composition comprising silica from a tire.

32. The method according to claim 31, wherein the tire is a scrapped tire.

33. A method for the manufacture of a precipitated silica, said method comprising:
recovering a silicate from a polymeric composition comprising silica by the method according to claim 17, and
using the recovered silicate to manufacture a precipitated silica.

34. The method according to claim 33, which further comprises recovering the polymeric composition comprising silica from a tire.

35. The method according to claim 34, wherein the tire is a scrapped tire.
